(19) United States
(12) Patent Application Publication
(10) Pub. No.: US 2008/0062978 A1
(43) Pub. Date: Mar. 13, 2008

(54) Interactive nat traversal method in session initiation protocol

(75) Inventors: Shaw Hwa Hwang, Taipei (TW); Yao Hsing Chung, Taipei (TW); Yu Wei Jhang, Taipei (TW); Chen Hung Wu, Taipei (TW); Chen Yi Wu, Taipei (TW); Kuan Lin Chen, Taipei (TW); Kuo Wei Liu, Taipei (TW); Chen Yu Yeh, Taipei (TW)

Correspondence Address: BACON & THOMAS, PLLC, 625 SLATERS LANE, FOURTH FLOOR, ALEXANDRIA, VA, 22314, US

(73) Assignee: Color City Enterprise Co., Ltd., Apia (WS)

(21) Appl. No.: 11/590,783

(22) Filed: Nov. 1, 2006

(30) Foreign Application Priority Data
Aug. 17, 2006 (TW) 095130178

(51) Int. Cl. H04L 12/56

(52) U.S. Cl. 370/389

(57) ABSTRACT

The present invention provides an interactive NAT (Network Address Translator) traversal method, i.e. INT (Interactive NAT Traversal) method, for solving the problems of SIP (Session Initiation Protocol) in Internet phone (VoIP) under current Internet environment. In other words, the present invention solves the SIP problems caused by NAT (Network Address Translator) and private (virtual) IP, so that P2P (Peer to Peer) transmission can traverse the NAT firewall directly.

The present invention uses the INT method on SIP, forming an interactive NAT traversal method in SIP (SIP with INT, SWINT), to solve the problems that SIP speech packets cannot transmit directly under NAT firewall.

### FIELD OF THE INVENTION

The present invention relates to an improvemet of the SIP (Session Initiation Protocol), and more particularly to an interactive NAT (Network Address Translator) traversal method in session initiation protocol, for improving the traversal of the SIP speech packets under the NAT firewall.

### BACKGROUND OF THE INVENTION

VoIP (Voice over Internet Protocol) is one of the popular communication technology. In VoIP, SIP (Session Initiation Protocol) defined by IETF is the most widely used protocol because of its simple structure, expandbility and easy operation.

In the present Internet environment, the IP addresses provided by IPv4 are not sufficient for ues, and more and more attackings by the hackers, thus NAT (Network Address Translator) or firewall are becoming a necessary installation for a computer system. As to a computer system with only one real IP address but many subcomputers, NAT not only provides one real IP address to handle a set of private (virtual) IP addresses, but also provides a simple Internet security for filtering packets due to the attackings by the hackers. However, NAT function induces the communication failure for P2P (Peer to Peer) applications.

SIP standard does not consider the problem that NAT function induces the communication failure for P2P (Peer to Peer) applications, so SIP standard cannot be used directly to an NAT Internet environment. This is a great disaster to SIP users, since statistically about 70% of the Interner users connect with the Internet through NAT, this means that only 30% of the Internet users can use SIP standard to conduct a VoIP communication.

Although up to the present there are many methods to be provided to solve the problems of NAT for SIP, these methods have to add more equipment or to replace the NAT equipment. Some of the methods only solve part of the NAT communication problems, in which the simplest way is to install a proxy server, but the cost to a VoIP provider is too high to afford.

### SUMMARY OF THE INVENTION

The object of the present invention is to provide a communication method to be applied to SIP and let the users under NAT to traverse the NAT of the opposite side for P2P (peer to peer) communication. This method does not need to modify any Internet protocol, and the simple structure can lower the cost of the VoIP provider significantly.

The benefits of the present invention of SWINT (SIP with Interactive NAT Traversal) method are: 1) SIP transmits speech packets directly under NAT environment without any proxy server; 2) It can be applied to any NAT environments; 3) The user do not need to modify the settings of the Internet environment; 4) The VoIP providers do not need to replace the SIP server; 5) The packets are too small to occupy the bandwidth.

### BRIEF DESCRIPTION OF THE DRAWINGS

FIG. 1 shows an example for SIP communication.

FIG. 2 shows the variations of the four parameters in packet transmitted between different networks.

FIG. 3 shows the SWINT system structure according to the present invention.

FIG. 4 shows the communication procedures of traversal the NAT firwall according to the SWINT protocol of the present invention.

FIG. 5 shows the communication procedures when the destination does not support SWINT protocol.

FIG. 6 shows the variation of the network parameters in INT procedures according to the present invention.

### DETAILED DESCRIPTION OF THE PREFERRED EMBODIMENTS

### Introduction to SIP

A message is the basic unit for SIP to set up a speech communication. The message can be classified to a “request” and a “response”. A request is an SIP message from a client to a server to express the purpose of the client; while a response is an SIP message from a server to a client to answer the request from the client.

SIP defines six request methods, including INVITE-CANCEL-BYE -ACK-REGISTER and OPTIONS, as shown in table 1 below.

TABLE 1
Six basic requests in SIP

| requests | descriptions |
|---|---|
| INVITE | To set up a new media session, or to alter the media |
| | characteristics of the present session (re-INVITE); a |
| | message body often accompanies with the INVITE |
| | request for describing/altering the media characteristics |
| | of the INVITE. |
| CANCEL | To cancel a session that is not set up yet (the final |
| | response is not received) to a server (UAS), and the |
| | server is under searching or ringing status. |
| BYE | To end up a successful session (the final response “2xx” |
| | has been received), a request terminal for INVITE or a |
| | receiving terminal can issue such request. |
| ACK | A request that the client (UAC, issuing an INVITE) |
| | confirms to the server that a final response is received. |
| REGISTER | SIP client (user agent) issues a registering request to a |
| | server, and the server records the IP address and |
| | communication port of the client. |
| OPTIONS | Inquiring the support ability of the opposite side. |

An SIP response is a message from a server to a client to answer the request from the client, as shown in table 2 below.

TABLE 2
Classification of SIP responses

| code range | responses | descriptions |
|---|---|---|
| 100~199 | Informational | The server has received a request, and |
| (1xx) | | the request is processed, but the |
| | | request is not accepted yet. |
| 200~299 | Success | The server accepts the request from |
| (2xx) | | the client. |
| 300~399 | Redirection | The request message has to be |
| (3xx) | | redirected to another server, and the |
| | | URL of the redirected server will be |
| | | shown on the header of “Contact”. |
| 400~499 | Client Error | The request cannot be processed |
| (4xx) | | because of the fault of the client, such |
| | | as the message is not identified, the |
| | | media is not supported or no such |
| | | person, . . . etc. According to the |
| | | instructions from the response |
| | | meassage, the client can issue a new |
| | | request to retry |
| 500~599 | Server Error | The request message cannot be |
| (5xx) | | processed because of the fault of the |
| | | server, but the client can issue the |
| | | request message to other server for |
| | | processing. |
| 600~699 | Global Error | The request message cannot be |
| (6xx) | | processed because of the fault of the |
| | | Internet environment, and the request |
| | | message cannot be issued to other |
| | | server for retry. |

### An Example for SIP Communication

The message exchange in an SIP communication is introduced. The example is a successful SIP speech flow (i.e. including the response of “2xx”), and the source (UAC), the destination (UAS) and SIP proxy server all use real IP address, thus there is no NAT problem.

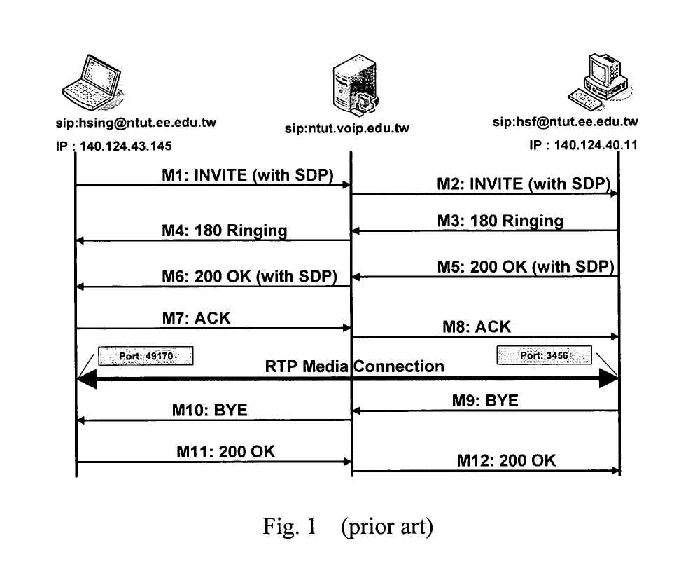

As shown in FIG. 1, a complete SIP communication is described, including the exchange of the SIP message and the packet transmission of the RTP media. In this example, the source has a user's account of “hsing” with SIP-URI of “sip:hsing@ntut.ee.edu.tw” and IP address of “140.124.43.145”. The destination has an account of “hsf” with SIP-URI of “sip:hsf@ntut.ee.edu.tw” and IP address of “140.124.40.11”. The source and the destination both have registered to the SIP proxy server successfully. The domain name of the SIP proxy server is “ntut.voip.edu.tw”.F

The communication flows in FIG. 1 are described as below:
M1: The source “Hsing” wants to communicate with the aceptor through SIP. The spaker “Hsing” issues “INVITE” request to the destination “Hsf” from the IP address “140.124.43.145” through SIP server “ntut.voip.edu.tw”, and mentions on the message that the RTP address thereof is “140.124.43.145:49170”.
M2: SIP server “ntut.voip.edu.tw” redirects the “INVITE” request to the destination “Hsf”.
M3: The destination “Hsf” responses with a “local ringing” message to SIP server “ntut.voip.edu.tw”.
M4: SIP server “ntut.voip.edu.tw” redirects the “local ringing” message to the source “Hsing” according to the record in Via header to the IP address “140.124.43.145”.
M5: The destination responses with an “accepting locally” message to SIP server “ntut.voip.edu.tw”, and mentions that the RTP address thereof is “140.124.40.11:3456”.
M6: SIP server “ntut.voip.edu.tw” redirects “accepting locally” message to the source “Hsing”.
M7: The source “Hsing” issues “ACK” request to SIP server “ntut.voip.edu.tw” to confirm “accepting locally” message.
M8: SIP server “ntut.voip.edu.tw” redirects “ACK” request to the destination “Hsf”.
M9: The destination “Hsf” ends the communication actively, and issues “BYE” request to SIP server “ntut.voip.edu.tw”.
M10: SIP server “ntut.voip.edu.tw” redirects “BYE” request to the source “Hsing”.
M11: The source “Hsing” receives the “BYE” request, and responses with “200 OK” to SIP server “ntut.voip.edu.tw”.
M12: SIP server “ntut.voip.edu.tw” redirects “200 OK” to the destination “Hsf”.

### Introduction to NAT

Network Address Translator (NAT) is generally used between a real network (public network) and a local network with private IP address, and can modify the IP address and communication port of a packet. When a packet is to be transmitted from a private network to a public network, NAT will modify the IP address and communication port of the packet into a unique real network address.

When a packet is to be transmitted out from a private network, NAT has to be used to modify the local network address into a real network address. This is because that there are many private networks connecting with the real network via NAT, these private networks use private IP addresses for internal use, but these private IP addresses may be similar with each other in different private networks. If these similar IPs appear on the real network simultaneously, the router will be confused and cannot decide which private network that packet is to be transmit to, causing unroutable.

Sometimes NAT is used for hiding the mechanisms of the local network, for block the exterior users. For example, the Network Address Translate Protocol is used to let all of the users of the internal nerwork to use only one real IP address to communicate with the external environment for hiding the internal network. This is so-called firewall mechanism to prevent an outside hacker from attacking the internal information of the NAT internal network.

Since the IP quantities provided by IPv4 is not enough to satisfy Internet client which is growing rapdly, the NAT provide a good solution to enterprises so that only a small amount of real IP addresses are applied, but a large amount private IP addresses can be created for internal use. In this way, not only the cost is reduced, but also a good network management and security is achieved. As to a home user, NAT let the home computers to communicate with the Internet with only one line without extra application.

### Operation Principle of NAT

The main duty for NAT is to change the IP address in a network packet, and make a mapping table for a private network and a real network. NAT has the capability of a router for analyzing the IP address of a packet, and deciding the routing for the packet, so NAT must have a routing table for recording the topology of the networks. In addition, NAT must have an IP mapping table for recording the real IP address and communication port corresponding to an internal private IP address in order to achieve the transformation for network address.

For example, an NAT has an IP address “X” in a public network (capital letter means a real network address of NAT, while a lowercase letter means a private network address inside NAT), and NAT internally has many private IP addresses xₙ, n=1,2,3 . . . , in which a computer with an private IP address xₖ wants to connect to a Web server with IP address “Y”, so said computer issues HTTP network packets from network port pₖ to network port P₈₀ of “Y”. Due to that this is a new connection, and there is no corresponding record in NAT mapping table, the Source Address (SA, S_{IP}=xₖ, S_{Port}=pₖ) issued from the network packet must be changed into the network address X:Pₖ of NAT, and then to be issued to the Destination Address (DA, D_{IP}=Y, D_{Port}=P₈₀). The mapping information will be recorded into the NAT mapping table. The network packet issued from the public network to X:Pₖ will be transmitted to the private network address xₖ:pₖ, of the NAT mapping table, and the Destination Address is changed from X:Pₖ to xₖ:pₖ.

Therefore, NAT refers the records on the NAT mapping table to do the change of network addresses, uses the IP address of NAT to match different network ports inside the internal network. If the exterior network wants to transmit packets to the computer of the internal network, it is necessary to know the NAT mapping records (i.e. the corresponding IP and port for that connection) for the internal network and exterior network.

### The Influence of NAT to P2P Application

A client ouside the NAT cannot connect directly with the client inside the NAT, and two clients locate inside at two different NATs respectively is impossible to make a direct connection. A P2P (Peer to Peer) transmission means that two clients connect directly to transmit information, but this is blocked by the NAT. A client under an NAT must transmit information to a real network client, and then the real network client transmits information to other client under the NAT. If the two clients locate under two different NATs, it is impossible to do P2P transmission, another server in the real network is necessary to bridge the two different clients located under two different NATs, said server is so-called a proxy/relay server.

### SIP (Session Initiation Protocol) with INT (Interactive NAT Traversal) Communication Protocol

### The Approach for Traversal Directly Through NAT Firewall

Four parameters are included in an IP network packet, i.e. source IP address, source communication port, destination IP address and destination communication port, in which the IP address is used to identify the device issuing the packet, the port number is used to identify the different connections on a same device.

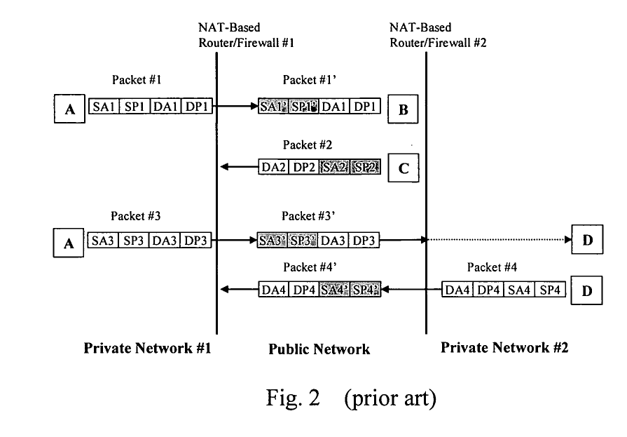

FIG. 2 describes the variations of the four parameters when a packet is transmitted between a public network and a private network. An A terminal and a D terminal are two private networks located under two different NATs respectively, while a B terminal and a C terminal are located at the public network. When A terminal issues Packet #1 to B terminal, Packet #1 includes SP1-SA1-DP1 and DA1 represrenting four parameters of source port-source address-destination port-destination address. After passing the firewall, SP1 and SA1 will be modified by NAT router #1 into SP1′ ‘ [symbol] ’ SA1′, and then NAT router #1 will pass Packet #1′ to B terminal, in which SA1′ is the real IP address of NAT router #1, and SP1′ is automatically defined by the port number of NAT router #1. After B terminal receives Packet #1′, B terminal can easily issue packet to the A terminal inside firewall #1 according to the four parameters in Packet #1′.

Meanwhile, if C terminal wants to issue Packet #2 to the A terminal in NAT router #1, and if the the NAT is a symmetric type NAT, the four parameters of Packet #2 satisfies the formulae as shown below, then Packet #2 can traverse NAT #1 to the A terminal

DA2=SA1′ (1)

DP2=SP1′ (2)

SA2=DA1 (3)

SP2=DP1 (4)

In which the four parameters DA2-DP2-SA2 and SP2 is controlled by C terminal, DA1 and DP1 is determined by A terminal, SA1′ and SP1′ is determined by NAT router #1. In formula (2), SP1′ is a parameter of Packet #1′, and only B terminal knows it. C terminal can guess SP1′ and set it as DP2, but the range of SP1′ is 0˜65535, the probability to guess correctly is only 1/65536. In formula (3), if C terminal and B terminal are not the same device, then formula (3) can not be satisfied, since the IP address DA1 of B terminal in formula (3) is not the same as the IP address SA2 of C terminal. Suppose the probability that formula (2) being satisfied is P₂, the probability that formula (3) being satisfied is P₃, then the probility P_{C2A} that C terminal can pass Packet #2 to A terminal successfully is shown in formula (5) below. Since P₃ is zero, P_{C2A} is zero.

P_{C2A}=P₂×P₃ (5)

D terminal plans to issue Packet #4 to A terminal, if the conditions shown as below are satisfied, then Packet #4′ can traverse NAT Firewall #1 to A terminal.

DA4=SA3′ (6)

DP4=SP3′ (7)

SA4′=DA3 (8)

SP4′=DP3 (9)

In which DA3 and DP3 are controlled by A terminal, DA4 and DP4 is determined by D terminal, and IP address SA3′ of NAT/Firewall #1 was known, IP address SA4′ of NAT/Firewall #2 was also known, so formula (6) and (8) is easily satisfied. Since Packet #3 cannot traverse Firewall #2, D terminal will not know the parameter SP3′ of Packet #3. But formulae (7) and (9) will be satisfied only when the Firewall #1 sets DP3 as SP4′ and D terminal guesses SP3′ successfully. However, DP3 cannot be set, and SP4′ cannot be known previously, so the probability that DP3 equals to SP4′ and the probability that D terminal guesses SP3′ successfully are both 1/65536, i.e, the probability that formula (7) and (9) are both satisfied is 1/4294967296. This means that the probability of two clients under two different firewalls to exchange packet is approaching zero.

If the variation of SP3′ and SP4′ is regular, and SP3′ and SP4′ can be predicted via some procedures, then the probability that two clients under two different firewalls to exchange packet directly is approaching 100%. Fortunately, the variation of the port number of NAT in commercial market is regular, this means that prediction of the variation of NAT network address is feasible.

### The Idea for Designing SWINT Communication Protocol

The SWINT (SIP with Interactive NAT Traversal) communication protocol in accordance with thepresent invention aims at that the SIP client under NAT firewall can transmit RTP packet P2P (peer to peer). The characteristics of the present SWINT communication protocol include:
1. The SIP client does not have to change any network settings to traverse NAT firewall.
2. SWINT communication protocol can traverse any kind of NAT firewall.
3. The instruction packet for traversing NAT firewall occupies only a very small part of the bandwidth.
4. The process to traverse NAT firewall is very clear and simple, and can be finished within a very short time.
5. The structure is simple to operate, and is cost effective.
6. SWINT communication protocol is independent with the SIP communication protocol, so that the existing SIP devices (e.g. servers) can continue to use.

### An Embodiment for SWINT Communication Protocol

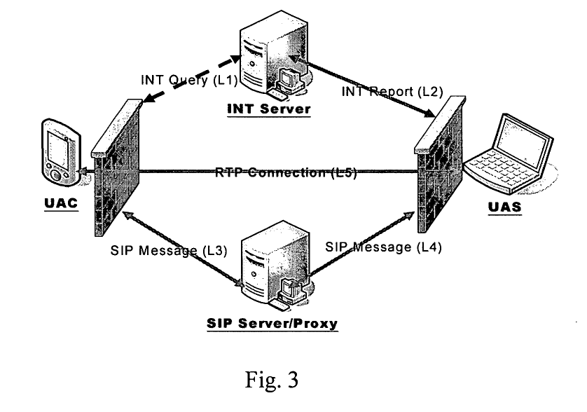

FIG. 3 shows SWINT (SIP with Interactive NAT Traversal) system structure according to the present invention. The system comprises INT (Interactive NAT Traversal) server and SIP proxy server, in which SIP proxy server plays the role of conventional SIP protocol, and is responsible for registration, forwarding, redirection for SIP clients. INT server is independent with the SIP proxy server, both don't know with each other. INT server has a proprietary format for message, and will not accept SIP message from the client.

If a client is located under an NAT firewall, the source (UAC) must first pass through INT server to ask the destination (UAS) for conducting prediction to variation of IP and Port (L1-L2 in FIG. 3), and set up a virtual/pre-established session L5 (in FIG. 3) according to the prediction. L5 is the RTP session (Media Session) for transmitting speech packet in SIP protocol, and then the convention SIP communication is processed (L3, L4 in FIG. 3).

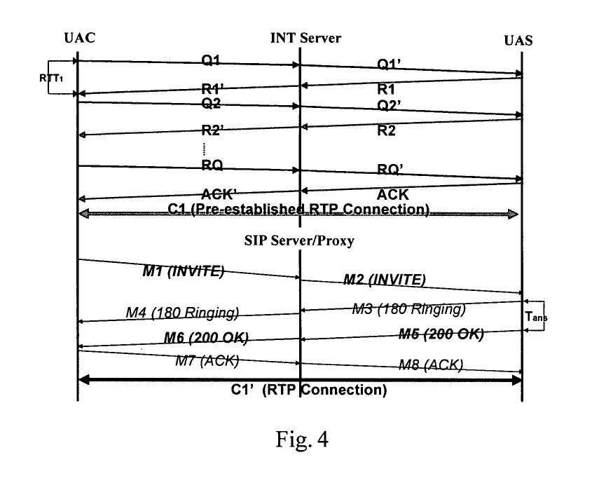

In FIG. 4, the detailed communication of FIG. 3 is described in detail. C1 line divides the processes into an upper part and a lower part. The lower part is the conventional process for SIP protocol, the upper part is the INT protocol (Interactive NAT Traversal) according to the present invention for predicting the variation of the network address.

In this embodiment, the source (UAC) and the destination (UAS) are located under NAT network environment, both use private IP, support the SWINT protocol, and register respectively to INT server (IS) and SIP server (SS) successfully. The IS network addresses of the source and the destination are NAT_Addr_1.IP_{UAC}: Port_{UAC} and NAT_Addr_2.IP_{UAS}: Port_{UAS} respectively; in which NAT_Addr_1 is the NAT address of the source for connecting with the public network, while NAT_Addr_2 is the NAT address of the destination for connecting with the public network. SS and IS are independent with each other, so SS does not have to support the SWINT protocol.

In FIG. 4, the prediction of the network address variation is interactive between UAC and UAS to collect NAT network parameters so as to achieve the traversal of NAT firewall, this is what so-called “Interactive NAT Traversal”. When the source wants to set up a speech connection with the destination, the procedures are described as below:
1. The source issues a request Q₁ from NAT_Addr_1.IP₁:Port₁ to IS (INT server) for prediction of the network address variation.
2. IS receives the requset Q₁ from the network address NAT_Addr_1.IP₁:Port₁, then IS add “NAT_Addr_1.IP₁:Port₁” to Q₁ to form Q₁′, and forward Q₁′ to the destination “NAT_Addr_2.IP_{UAS}: Port_{UAS}”.
3. After Q₁′ is received, the destination reponse with R₁ from NAT_Addr_2.IP₁′:Port₁′ to IS.
4. After IS receives the response from NAT_Addr_2.IP₁′ :Port₁′ R₁, IS will add NAT_Addr_2.IP₁′:Port₁′ to R₁ to form R₁′, and forward R₁′ the source NAT_Addr_1.IP_{UAC}: Port_{UAC}.
5. The source obtains NAT_Addr_1.IP₁:Port₁ and NAT_Addr_2.IP₁′: Port₁′ from R₁′, and records the time interval RTT₁ (Round Trip Time) from issuing Q₁ till receiving R₁′, and the time interval RTT₂ between Q₂ [symbol] R₂′, and so on.
6. The source repeats the steps 1˜5 until the variation rules of the IP and Port in between are observed, or until an upper limit L₁ for the number of times in predicting the variation of the network addresses is reached, then stop the request for predicting the variation of the network addresses.
7. If the source discovers the variation rules for IP and Port in between, and can predict that NAT_Addr_1.IPₙ:Portₙ, NAT_Addr_2.IPₙ′:Portₙ′ will be used to transmit messages, and calculate the average RTT as RTT_{avg}, then the source issues a connection request RQ₁ from NAT_Addr_1.IP_{UAC}: Port_{UAC} to IS. RQ₁ records the prediction of NAT_Addr_1.IPₙ:Portₙ, NAT_Addr_2.IPₙ′:Portₙ′ and RTT_{avg}. The calculation of RTT_{avg} is shown as formula (10) below, in which N is the number of times for prediction the variation of the network address.

$${RTT}_{avg} = \frac{1}{2 ( N + 1 )} {\sum }_{n = 0}^{N} {RTT}_{n} \qquad ( 10 )$$

8. IS forwards RQ₂ ( i.e. RQ₁) to IP_{UAS}:Port_{UAS} of the destination.
9. The destination receives RQ₂, then responses with ACK₁(different from ACK in SIP) from NAT_Addr_2.IP_{UAS}:Port_{UAS} [symbol] IS. After a time interval of RTT_{avg}/2, the connection between NAT_Addr_2.IPₙ′:Portₙ′ to NAT_Addr_1.IPₙ: NAT_Addr_1.Portₙ is achieved.
10. IS forwards ACK₂ (i.e. ACK₁) to NAT_Addr_2.IP_{UAC}:Port_{UAC} of the source∘
11. After the source receives ACK₂, the connection between NAT_Addr_1.IPₙ:Portₙ and NAT_Addr_2.IPₙ′: Portₙ′ is achieved immediately.
12. If the prediction is correct, then C₁ connection is set up successfully, otherwise repeat the above steps until C₁ connection is set up successfully or the repeat times reach an upper limit L₂.
13. If C₁′ is set up successfully, then the source issues SIP request message “INVITE” (lines M₁, M₂ in FIG. 4), and NAT_Addr_1.IPₙ: Portₙ is filled into related field of the RTP connection in SDP.
14. The destination responses with “200 OK” (lines M₅, M₆ in FIG. 4) SIP message, and fills NAT_Addr_2.IPₙ′:Portₙ′ into related field of the RTP connection in SDP.
15. Both sides transmit speech packets via C₁ (i.e. the C₁ connection set up previously).

When the source finishes the prediction of the network address variation, and set up a first UDP connection (C₁), a second or a third connections can be set up according to the prediction of the network address variation for RTCP or image transmission. After both sides finished the speech communication, C₂ can be connected continuely in a predetermined time period (1˜5 minutes) for transmitting any packet, preventing C₂ from breaking off by NAT firewall. In this way, if both sides want to connect for speech communication, the prediction for the network address variation can be omitted, and go directly the SIP message exchange.

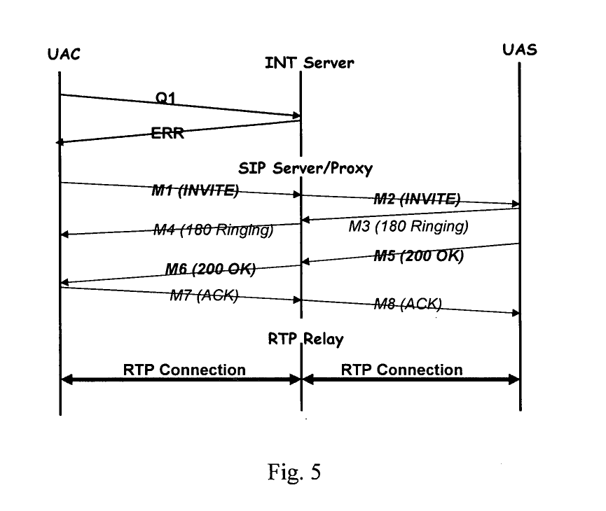

If the acceoptor does not support SWINT protocol, the entire communication will not fail, as shown in FIG. 5, both sides can exchange SIP message via SS and set up RTP speech connection. The difference is that the RTP speech connection is not set up in advance, but set up after SIP message exchange. In addition, the RTP speech connection between both sides still exchange speech packets indirectly via RTP Relay.

When the source wants to set up a speech connection with the destination, the procedures are described as below. The IPs and Ports represent the most outside of NAT public network of both sides.
1. The source issues a request Q₁ from IP₁:Port₁ to IS for prediction the variation of network address.
2. IS receives the request Q₁ from the source, but the network address of the destination is not found (maybe the destination is not on line or the destination does not support the SWINT protocol), so IS responses with ER (Error Report) to IP_{UAC}:Port_{UAC} of the source, and maintains the ER code in the response message.
3. The source receives the response message ER from IS, interprets the ER message, and stops the prediction of network address variation.
4. The source issues SIP request message “INVITE” to SS (line M₁ in FIG. 5) asking for setting up an SIP speech communication according to standard SIP protocol.
5. Both sides finish the exchange of SIP messages. SS redirects the speech packets of both sides to RTP server for exchange by modifying the SDP field in SIP message of both sides.

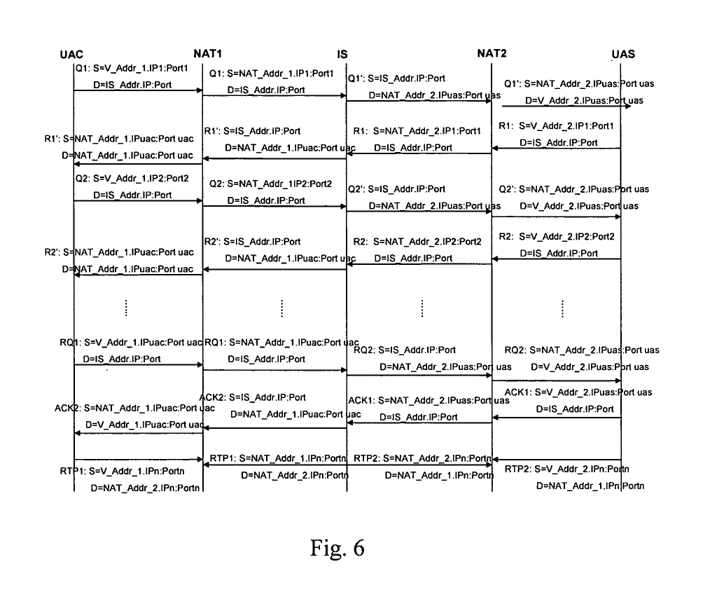

FIG. 6 shows the message transmitting situations between the source and the destination with interactive traversal NAT (INT) process, in which UAC is the source, UAS is the destination, NAT1 is the Network Address Translator of the source connecting with the public network, NAT2 is the Network Address Translator of the destination connecting with the public network, IS is an INT (interactive traversal NAT) server. The network parameters in the message only shows the network addresses of the source terminal and the destination terminal, in which V_Addr_1 is the private network address of the source under NAT1, V_Addr_2 is the private network address of the destination under NAT2. NAT_Addr1 is the real network address of NAT1. NAT_Addr2 is the real network address of NAT2. IS_Addr is the real network address of IS. Each network address comprises IPₖ:Portₖ, in which IP is the internet address, Port is the communication port. The suffixes k=1,2,3 . . . represent different IPs and Ports. Generally IP₁, IP₂, IP₃ . . . IPₙ will have the same value. IP_{uac}:Port_{uac} is the network address of the source to register to IS, IPᵤₐₛ:Portᵤₐₛ is the network address of the destination to register to IS.

The numerical value in table 3 is filled into FIG. 6, it is seen that the network address variation and the corresponding real network addresses of the source terminal and the destination terminal under the NAT thereof. It is observed from table 3 the variation of the two NAT ports (suppose IP is not changed), in which the variation of the port of NAT₁ is increased by 2 each time, while NAT₂ is increased by 1 each time. When the last testing result is NAT_Addr_1.Portₙ₋₁=62226 and NAT_Addr_2.Portₙ₋₁=64506, we can predict NAT_Addr_1.Portₙ=62228 and NAT_Addr_2.Portₙ=64507, and then the source issues RTP₁ packet from S₁=140.124.43.168:62228 to D₁=219.80.42.35:64506, while the destination issues RTP₂ packet from S₂=219.80.42.35:64506 to D₂=140.124.43.168:62228. According to the operation principle of NAT, when the network address of the source terminal of the packet received by NAT is the same as the destination address recorded by the packet of the port previously (i.e. D₁=S₂, D₂=S₁), then the traversal of NAT is achieved. In this example, the packets of RTP₁ and RTP₂ can transmit to the source and destination under NAT successfully.

TABLE 3
INT

[symbol]

[symbol]

| Network parameter | Corresponding value | Network parameter | Corresponding value |
|---|---|---|---|
| V_Addr_1.IP | 192.168.0.14 | V_Addr_2.IP | 10.1.10.117 |
| V_Addr_1.Port_{uac} | 5070 | V_Addr_2.Portᵤₐₛ | 5070 |
| V_Addr_1.Port₁ | 1440 | V_Addr_2.Port₁ | 1221 |
| V_Addr_1.Port₂ | 1441 | V_Addr_2.Port₂ | 1222 |
| V_Addr_1.Port₃ | 1442 | V_Addr_2.Port₃ | 1223 |
| NAT_Addr_1.IP | 140.124.43.168 | NAT_Addr_2.IP | 219.80.42.35 |
| NAT_Addr_1.Pore_{uac} | 61004 | NAT_Addr_2.Portᵤₐₛ | 63412 |
| NAT_Addr_1.Port₁ | 62210 | NAT_Addr_2.Port₁ | 64498 |
| NAT_Addr_1.Port₂ | 62212 | NAT_Addr_2.Port₂ | 64499 |
| NAT_Addr_1.Port₃ | 62214 | NAT_Addr_2.Port₃ | 64500 |
| NAT_Addr_1.Portₙ₋₁ | 62226 | NAT_Addr_2.Portₙ₋₁ | 64506 |
| NAT_Addr_1.Portₙ | 62228 | NAT_Addr_2.Portₙ | 64507 |
| IS_Addr.IP | 210.63.32.137 | | |
| IS_Addr.Port | 5070 | | |

While we have shown and described an embodiment in accordance with the present invention, it is clear to those skilled in the art that further embodiments may be made without departing from the scope of the present invention.

What is claimed is:

1. An interactive NAT (Network Address Translator) traversal method in session initiation protocol (SIP), comprises an INT server and an SIP proxy server; wherein the SIP proxy server plays the role of conventional SIP communication, and is responsible for the registration, forwarding and redirection of an SIP message for an SIP client; the INT server is independent with the SIP proxy server, both don't know with each other; a source terminal and a destination terminal are under the NAT network environment, and register respectively to both the SIP proxy server and the INT server; the INT server has a proprietary message format, and does not accept the SIP message from the source terminal and the destination terminal; the source terminal must first utilize the INT server and request the destination terminal to conduct a prediction for the variation of network address, and set up a communication connection according to the prediction, then conduct a conventional SIP communication.

2. An interactive NAT (Network Address Translator) traversal method in session initiation protocol (SIP) according to claim 1, comprising the steps as below:
a. the source terminal issues an NAT network address thereof and a request for prediction the network address variation to the INT server;
b. the INT server forwards the NAT network address of the source terminal to the destination via an INT network address of the destination terminal;
c. After the destination terminal receives the request, the destination terminal reponses with an NAT network address thereof to the INT server;
d. the INT server forwards the NAT network address of the destination terminal to the source terminal;
e. The source terminal records the NAT network address of the source terminal and the NAT network address of the destination terminal, and records a time interval RTT (Round Trip Time) from issuing the quest till receiving the NAT network address of the destination terminal;
f. the source terminal repeats the steps a˜e until the variation rules of the NAT network addresses of the source terminal and the destination terminal are observed, or until an upper limit L₁ for the number of times in predicting the variation of the network addresses is reached, then stop the request for predicting the variation of the network addresses;
g. If the source terminal discovers the variation rules of the NAT network addresses of the source terminal and the destination terminal, and can predict the following addresses of the source terminal and the destination terminal, and calculates the average of RTTs as RTT_{avg}, then the source terminal issues a connection request from NAT network address of the INT server to the INT server; the connection request records the prediction of the source terminal and RTT_{avg};
h. The INT server forwards the connection request to the destination terminal via the INT network address of the destination terminal;
i. the destination terminal receives the connection request, then responses to the INT server from the network address of the destination terminal of the INT server; and within a time interval of RTT_{avg}/2 to achieve a connection from the NAT network address of the destination terminal to the NAT network address of the source terminal;
j. the INT server responses to the source terminal via the INT network address of the source terminal;
k. After the source terminal receives the response from the INT server, the source terminal sets up a connection from the NAT network address of the source terminal to the NAT network address of the destination terminal;
l. If the prediction is correct, then the connection in step k is set up successfully, otherwise repeat the above steps until a connection is set up successfully or until the repeat times reach an upper limit L₂;
m. If the connection in step k is set up successfully, then the source terminal issues SIP request message “INVITE”, and fills the NAT network address of the source terminal to a table;
n. the destination terminal responses with “200 OK” SIP message, and fills the NAT network address of the destination terminal to the table;
o. the source terminal and the destination terminal transmit speech packets via the connection in step k.

3. An interactive NAT (Network Address Translator) traversal method in session initiation protocol (SIP) according to claim 2, wherein the RTT_{avg} in step g is calculated by the formula below:
$${RTT}_{avg} = \frac{1}{2 ( N + 1 )} {\sum }_{n = 0}^{N} {RTT}_{n}$$
in which N is the number of times in predicting the variation of the network addresses, RTTₙ is one of the time intervals (Round Trip Time), RTT_{avg} is the average time interval.
